(19) United States
(12) Patent Application Publication
(10) Pub. No.: US 2026/0219077 A1
(43) Pub. Date: Jul. 30, 2026

(54) Sensor Assembly for a Vehicle

(71) Applicant: Robert Bosch GmbH, Stuttgart (DE)

(72) Inventors: Christian Linss, Wutha-Farnroda (DE); Axel Kiersten, Oberstenfeld (DE); Matthias Letzgus, Rosenberg (DE); Eduard Maiterth, Heilbronn (DE)

(21) Appl. No.: 19/147,705

(22) PCT Filed: Jan. 16, 2024
(86) PCT No.: PCT/EP2024/050857

§ 371 Date: Jul. 13, 2025

(30) Foreign Application Priority Data
Jan. 17, 2023 (DE) 10 2023 200 308.2

(51) Int. Cl. G01D 11/24; B60R 16/023

(52) U.S. Cl. CPC G01D 11/245; B60R 16/0231

(57) ABSTRACT

A sensor assembly for a vehicle is disclosed, having a sensor housing and a plug connection between a plug housing, which is connected to a sensor housing and in which at least one first contact element is arranged, and a plug, which is connected to at least one connection cable and includes at least one second contact element cooperating with the first contact element to establish an electrical connection. The plug is inserted into a receiving opening of the plug housing in such a way that the at least one second contact element and the at least one first contact element establish the electrical connection. The plug is non-detachably connected to the plug housing via a welded joint, in particular a laser transmission welded joint, which forms a fluid-tight radial seal between the plug and the plug housing. A method for mounting such a sensor assembly for a vehicle is also disclosed.

The invention relates to a sensor assembly for a vehicle. The object of the present invention is a method for assembling such a sensor assembly for a vehicle.

Prior art discloses sensor assemblies for vehicles with a sensor housing and a detachable plug connection between a plug housing connected to a sensor housing and a plug connected to at least one connection cable. Furthermore, direct cable connections for sensor assemblies are known, in which a cable jacket of the connection cable is molded into, glued onto or laser-welded onto the sensor assembly in a fluid-tight manner. The fluid-tight molding of connection cables is technically challenging, especially with regard to sealing over the lifetime and handling the connection cable on part carriers, and it is expensive.

DE 10 2017 216 533 A1 discloses a sensor unit comprising a holder with at least two busbars. An internal electric interface for at least one sensor is provided on first ends of the at least two busbars, and an external electric interface for a plug module is formed on second ends of the at least two busbars. In this case, an alignment component encompasses the at least two busbars and is arranged between the internal electrical interface and the external electrical interface. The direction of the alignment component defines the output direction of the second ends of the at least two busbars and the external electrical interface. The second ends of the at least two busbars may each be configured as contact pins of the plug module, which may be electrically connected with receiving contacts of a plug-in module. The plug module of the sensor unit and the plug-in module form a detachable plug connection.

DE 20 2014 106 056 A1 discloses a hermetically sealing plug connector, which comprises two detachable plugs with mutually adapted front housing components as well as mutually adapted electrical contact elements. The two front housing components overlap regions facing one another in the plugged-in state. The two front housing components seal by means of a sealing lip arranged on one front housing component as well as by means of an annular groove arranged on the other front housing part, which is surrounded inwardly by annular circumferential sealing surfaces and outwardly by an annular circumferential collar, which, when the two plug components are plugged into one another, extends outwardly.

### DISCLOSURE OF THE INVENTION

The sensor assembly for a vehicle with the features of independent claim 1 has the advantage that manufacture of sensor assemblies with a detachable plug connection for at least one connection cable as well as sensor assemblies with non-detachable plug connection for at least one connection cable can be carried out on the same production line design.

In a sensor assembly with a detachable plug connection, a plug component is arranged directly on a part of the sensor housing and a corresponding receiving plug component is mounted on the at least one connection cable. For various reasons, some customers require a sensor with a direct cable outlet.

In embodiments of the sensor assembly according to the invention, the connection cable is not transported through all manufacturing steps of the existing production line, but rather a corresponding plug connection between a plug housing connected to a sensor housing and a plug with the connection cable is only made at the end of the manufacturing process. The plug is then connected to the plug housing in a fluid-tight manner via a welded connection, in particular a laser transmission welded connection. As a result, the entire sensor assembly and the at least one connection cable do not have to be overmolded, which may be problematic for the electronic components of the sensor assembly due to the temperatures. In addition, the detachable plug connection already used for sensor assemblies can be retained to a large extent. The technical risk is also low because the plug connection is based on a previously tested plug technique.

Embodiments of the present invention provide a sensor assembly for a vehicle, having a sensor housing and a plug connection between a plug housing, which is connected to a sensor housing and in which at least one first contact element is arranged, and a plug, which is connected to at least one connection cable and comprises at least one second contact element cooperating with the first contact element to establish an electrical connection. The plug is inserted into a receiving opening of the plug housing in such a way that the at least one second contact element and the at least one first contact element establish the electrical connection. The plug is non-detachably connected to the plug housing via a welded joint, in particular a laser transmission welded joint, which forms a fluid-tight radial seal between the plug and the plug housing.

In addition, a method for assembling such a sensor assembly for a vehicle is proposed. For this purpose, a sensor housing and, as a function of a sensor concept and a communication protocol to be implemented, a plug housing with at least one first contact element and one circuit carrier with an electronic circuit and a plug with at least one second contact element and at least one connection cable are provided. The at least one first contact element and the circuit carrier are connected to each other at an internal interface. The circuit carrier is inserted into the sensor housing and the plug housing and the sensor housing are connected to each other at a connection area. In order to establish a direct cable connection, the plug with at least one second contact element is inserted into a receiving opening of the plug housing in such a way that the at least one second contact element and the at least one first contact element establish an electrical connection at an external interface. In addition, the plug is non-detachably connected to the plug housing via a welded joint, in particular a laser transmission welded joint, which forms a fluid-tight radial seal between the plug and the plug housing.

To establish the welded joint, in particular the laser transmission welded joint, the plug and/or the plug housing can be prepared accordingly in the area of the welded joint to be established. For example, a sealing element for sealing the individual wires can be mounted on the plug. In addition, contact elements connected to the individual wires of the connection cable can be pressed into the plastic part of the plug. Since a non-detachable connection between the two joining parts takes place through the welded connection, snap tabs or flaps for fixing the plug in the plug housing can be omitted. The forces normally transmitted via the outer ribs, such as vibrations, etc., may also be compensated with the welded joint. Thus, such guide ribs and/or connecting collars may also be omitted. Since the welded connection between the plug and the plug housing acts as a radial seal, an additional radial seal can also be omitted. Due to the elimination of the guide ribs or connecting collars and the snap tabs or flaps, building space can advantageously be saved. In addition, manufacturing of the plug can be simplified with plastic injection molding.

For example, embodiments of the sensor assembly for a vehicle may configured as speed sensors with an ASIC (ASIC: application-specific integrated circuit) or redundantly with two ASICs or with an ASIC having two sensor elements, temperature sensors, microphones, etc. The speed sensors can be equipped with HALL, AMR, GMR, TMR or comparable measurement technology.

The plug housing and the sensor housing of the sensor assembly can preferably each be designed as plastic injection molding components. Doing so enables simple and cost-effective manufacturing in large quantities.

Advantageous improvements to the sensor assembly for a vehicle specified in independent claim 1 and to the method specified in independent claim 10 for assembling a sensor assembly for a vehicle are made possible by the measures and further developments listed in the dependent claims.

It is particularly advantageous that a circuit carrier with an electronic circuit can be arranged in the sensor housing. For example, an electronic circuit can be understood to be an analysis and control circuit, which processes or evaluates acquired sensor signals. The electronic circuit can comprise at least one interface, which can be designed as hardware and/or software. For example, given a hardware design, the interfaces can be part of what is referred to as an ASIC system, which contains a wide variety of functions of the electronic circuit. However, it is also possible that the interfaces are dedicated integrated circuits or consist at least partly of discrete components. When implemented as software, the interfaces can be software modules present, for example, on a microcontroller alongside other software modules. Also advantageous is a computer program product comprising program code stored on a machine-readable carrier, e.g., a semi-conductor memory, a hard disk memory, or an optical memory and used in order to perform the evaluation when the program is executed by the electronic circuit.

In an advantageous embodiment of the sensor assembly, the plug housing and a first end of the at least one first contact element projecting into the plug housing can form an external interface of the sensor assembly. A second end of the at least one first contact element opposite the first end may be connected to the circuit carrier and form an internal interface of the sensor assembly. The number and arrangement of the at least one first contact element and the at least one second contact element can be adapted to a communication protocol to be implemented. By means of the plug assembly with the at least one first contact element, the external interface of the sensor assembly can be adjusted in advance to a bus topology desired by the customer, while a mechanical interface between the sensor housing and the plug housing or between the plug housing and the plug can be implemented in the same way. For example, two-pole or four-pole or eight-pole plug connections can be provided, which can meet corresponding requirements for signal transmission and communication protocols. By means of embodiments of the sensor assembly, for example, an A2B interface can also be easily implemented as an external interface with a direct cable connection, in which the required plug pins are placed in the plug housing with as small a distance as possible, in order to be able to implement a high transmission frequency of the external interface similar to a network interface (100 Mbit). Furthermore, the external interface of the sensor assembly with a direct cable connection can be designed as a MOST bus interface, 100BASE-T1 interface, PSI5 interface, CAN interface, CAN FD interface, VIAS interface, etc.

In another advantageous embodiment of the sensor assembly, the at least one first contact element configured as a contact pin can be pressed into the plug housing and electrically conductively connected to at least one conductive track structure of the circuit carrier. This contacting of the at least one first contact element can additionally establish mechanical fixation of the circuit carrier on the plug side. In order to minimize load on the contact points, the plug housing in the area of the first interface can comprise at least one support element adjacent to the circuit carrier. For example, the at least one support element can be attached to or formed in the plug housing as an additional support lug.

In another advantageous embodiment of the sensor assembly, the plug housing can comprise a first connection flange at an end opposite the receiving opening, which is connected to a second connection flange of the sensor housing. The first connection flange of the plug housing and the second connection flange of the plug housing can be connected in a fluid-tight manner to one another via a welded connection, or via an adhesive connection, or via a screw connection, or via a press-fit connection, or via a hot melt connection, or via a combination of the connection techniques specified.

In another advantageous embodiment of the sensor assembly, at least one fastening tab can be formed on the sensor housing. This makes it easy to implement a screw point for the sensor assembly with a pressed-in or overmolded bushing. In addition, the use of a loss-proof screw is also conceivable. For example, as a second attachment point, compression ribs or an outer geometry of the sensor housing can be employed.

Exemplary embodiments of the invention are illustrated in the drawings and explained in more detail in the following description. In the drawings, identical reference signs refer to components or elements performing identical or similar functions.

### BRIEF DESCRIPTION OF THE DRAWINGS

FIG. 1 shows a schematic perspective view of an exemplary embodiment of a sensor assembly according to the invention.

FIG. 2 shows a schematic top view of a sensor assembly for a vehicle according to FIG. 1.

FIG. 3 shows a schematic sectional view of the sensor assembly of FIGS. 1 and 2 according to the invention along the interface III-III.

FIG. 4 shows a schematic flowchart of an exemplary embodiment of a method for mounting a sensor assembly for a vehicle according to the invention.

### EMBODIMENTS OF THE INVENTION

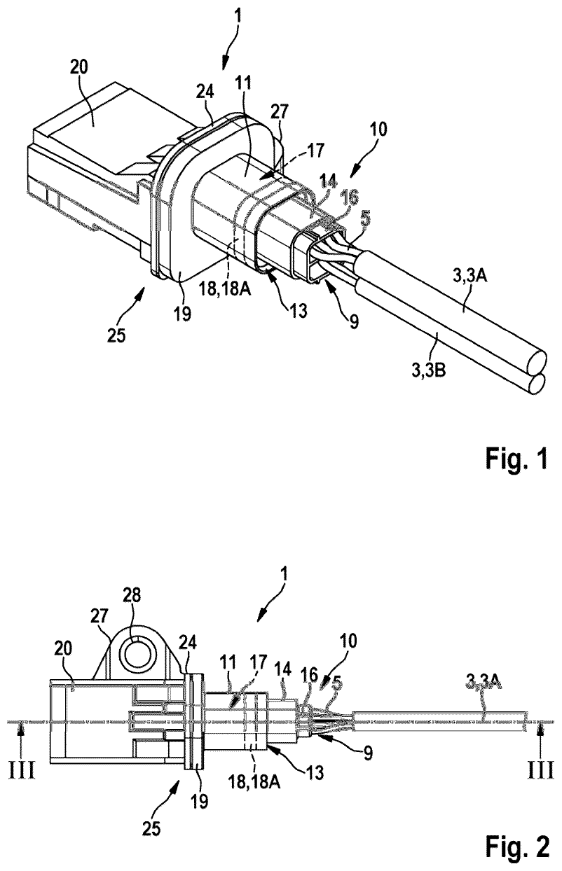

As can be seen from FIGS. 1-3, the illustrated exemplary embodiments of a sensor assembly 1 according to the invention for a vehicle comprises a sensor housing 20 and a plug connection 10 between a plug housing 11, which is connected to a sensor housing 20 and in which at least one first contact element 12 is arranged, and a plug 14, which is connected to at least one connection cable 3 and comprises at least one second contact element 15 cooperating with the first contact element 12 to establish an electrical connection. The plug 14 is inserted into a receiving opening 13 of the plug housing 11 in such a way that the at least one second contact element 15 and the at least one first contact element 12 establish the electrical connection. The plug 14 is non-detachably connected to the plug housing 11 via a welded joint 18, in particular a laser transmission welded joint, which forms a fluid-tight radial seal 18A between the plug 14 and the plug housing 11.

The plug housing 11, the sensor housing 20 and the plug 14 are respectively embodied as plastic injection molding components in the illustrated exemplary embodiment of the sensor assembly 1.

As can be seen further from FIGS. 1 to 3, in the illustrated exemplary embodiment of the sensor assembly 1, two connection cables 3 are electrically contacted with the plug 14 at a cable receptacle 16. A top first connection cable 3A comprises four wires 5, and a bottom second connection cable 3B comprises two wires 5 in the illustration. Therefore, the plug 14 comprises a total of six second contact elements 15 configured as contact receivers 15A, which receive six first contact elements 12 configured as contact pins 12A, to establish the electrical connection.

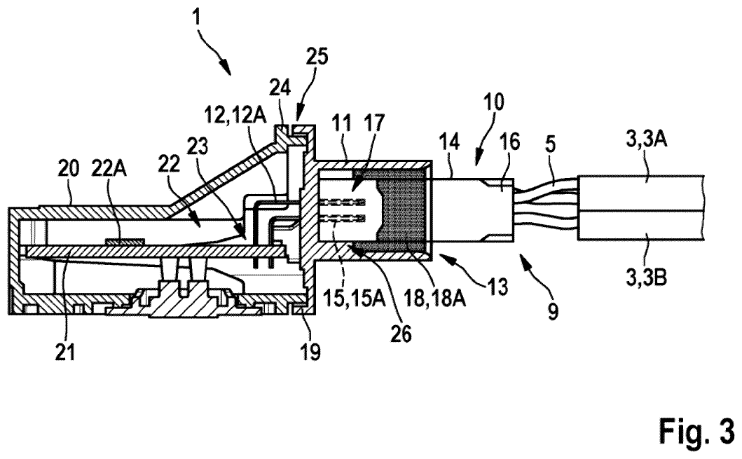

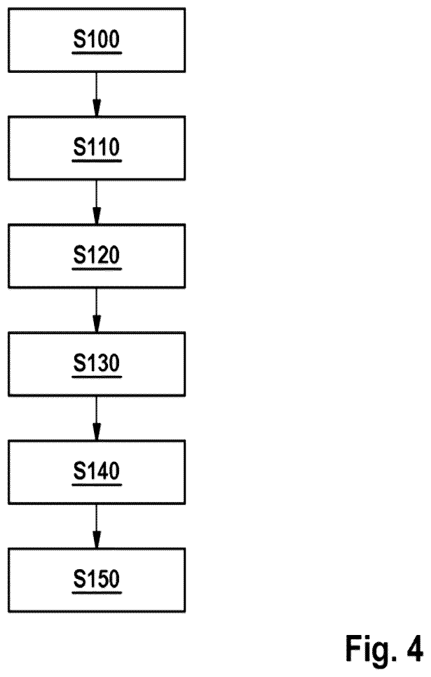

As can be further seen particularly in FIG. 3, a circuit carrier 21 with an electronic circuit 22 is arranged in the sensor housing 20. In the illustrated exemplary embodiment, an ASIC component 22A is arranged on the circuit carrier 21 as part of the electronic circuit 22. Of course, the electronic circuit 22 can also comprise further active or passive electronic components not shown in more detail herein.

The plug housing 11 and first ends of the six first contact elements 12 projecting into the plug housing 11 form an external interface 17 of the sensor assembly 1. Second ends of the six first contact elements 12 opposite the first ends are connected to the circuit carrier 21 and form an internal interface 23 of the sensor assembly 1. The number and arrangement of the six first contact elements 12, configured as contact pins 12A, are adapted to the communication protocol to be implemented. In the illustrated exemplary embodiment, the six first contact elements 12 are pressed into corresponding, not further specified contact openings of the plug housing 11 such that the first ends of the six first contact elements 12 project into the interior of the plug housing 11. The second ends of the six first contact elements 12 are pressed into corresponding, not further specified vias of the circuit carrier 21. Alternatively, the second ends of the first contact elements 112 may be soldered in the vias. Using the vias, the first contact elements 12 are electrically connected to at least one conductive track structure of the circuit carrier 21 (not shown in detail).

As can be seen further from FIGS. 1 to 3, the plug housing 11 has a first connection flange 19, which is connected to a second connection flange 24 of the sensor housing 20, at an end opposite to the receiving opening 13. In the illustrated exemplary embodiment, the first connection flange 19 of the plug housing 11 and the second connection flange 24 of the sensor housing 20 are connected to each other in a fluid-tight manner via a welded connection. Of course, the sensor housing 20 and the plug housing 11 can also be connected in a fluid-tight manner via other connection techniques, e.g., via an adhesive connection, or via a press-fit connection, or via a hot melt connection or a screw connection, or via a combination of the connection techniques specified.

As further seen in FIG. 2 in the illustrated exemplary embodiment of the sensor assembly 1, a fastening tab 27 is formed on the sensor housing 20. In this case, a fastening bushing 28 is pressed into the fastening tab. To fasten the sensor assembly 1, a screw can be passed through the fastening bushing 28 and the sensor assembly 1 can be screwed at the installation location.

As further seen in FIG. 6, the illustrated exemplary embodiment of a method 100 according to the invention for assembling such a sensor assembly 1 for a vehicle comprises a step S100, in which a sensor housing 20 is provided. As a function of a sensor concept and a communication protocol to be implemented, a plug housing 11 with at least one first contact element 12 and one circuit carrier 21 with an electronic circuit 22 and a plug 14 with at least one second contact element 15 and at least one connection cable 3 are provided in step S100. In a step S110, the at least one contact element 12 and the circuit carrier 14 are connected to each other at an internal interface 23. In a step S120, the circuit carrier 14 is inserted into the sensor housing 20. In a step S130, the plug housing 11 and the sensor housing 20 are connected to each other at a connection area 25. To form a direct cable connection, in a step S140, the plug 14 with at least a second contact element 15 is inserted into a receiving opening 13 of the plug housing 11 such that the at least one second contact element 15 and the at least one first contact element 12 establish an electrical connection at an external interface 17. In a step S150, the plug 14 is non-detachably connected to the plug housing 11 via a welded joint 18, in particular a laser transmission welded joint, which forms a fluid-tight radial seal 18A between the plug 14 and the plug housing 11.

1. A sensor assembly for a vehicle, comprising:
a sensor housing;
a plug housing connected to the sensor housing and having at least one first contact element arranged therein;
a plug connected to at least one connection cable and having at least one second contact element, wherein the at least one second contact element is configured to cooperate with the at least one first contact element to establish an electrical connection; and
a plug connection between the plug housing, and the plug,
wherein the plug is configured to be inserted into a receiving opening of the plug housing in such a way that the at least one second contact element and the at least one first contact element establish the electrical connection, and
wherein the plug is non-detachably connected to the plug housing via a welded joint, which forms a fluid-tight radial seal between the plug and the plug housing.

2. The sensor assembly according to claim 1, further comprising a circuit carrier is arranged in the sensor housing and having an electronic circuit.

3. The sensor assembly according to claim 1, wherein the plug housing and a first end of the at least one first contact element projecting into the plug housing form an external interface of the sensor assembly.

4. The sensor assembly according to claim 3, wherein a second end of the at least one first contact element opposite the first end is connected to the circuit carrier, and forms an internal interface of the sensor assembly.

5. The sensor assembly according to claim 1, wherein the number and arrangement of the at least one first contact element and the at least one second contact element are adaptable to a communication protocol to be implemented.

6. The sensor assembly according to claim 2, wherein the at least one contact element is configured as a contact pin and pressed into the plug housing and electrically conductively connected to at least one conductor track structure of the circuit carrier.

7. The sensor assembly according to claim 1, wherein the plug housing has a first connection flange at an end opposite to the receiving opening, which is connected to a second connection flange of the sensor housing.

8. The sensor assembly according to claim 7, wherein the first connection flange of the plug housing and the second connection flange of the sensor housing are connected in a fluid-tight manner via a welded connection, or via an adhesive connection, or via a press-in connection, or via a hot melt connection, or via screw connection, or via a combination of the connection techniques specified.

9. The sensor assembly according to claim 1, wherein at least one fastening tab is formed on the sensor housing.

10. A method for assembling a sensor assembly for a vehicle, which is embodied in accordance with claim 1, wherein a sensor housing and a plug housing, depending on a sensor concept and a communication protocol to be implemented, are provided with at least one first contact element and a circuit carrier with an electronic circuit and a plug with at least one second contact element and at least one connection cable, wherein the at least one first contact element and the circuit carrier are connected to one another at an internal interface, wherein the circuit carrier is inserted into the sensor housing and the plug housing and the sensor housing are connected to one another in a connection area, wherein in order to form a direct cable connection the plug with at least one second contact element is inserted into a receiving opening of the plug housing in such a way that the at least one second contact element and the at least one first contact element establish an electrical connection at an external interface, wherein the plug is connected to the plug housing via a welded joint, which forms a fluid-tight radial seal between the plug and the plug housing.

11. The sensor assembly according to claim 1, wherein the welded joint is a laser transmission welded joint.

12. The method according to claim 10, wherein the welded joint is a laser transmission welded joint.
